(19) United States
(12) Patent Application Publication
(10) Pub. No.: US 2010/0264673 A1
(43) Pub. Date: Oct. 21, 2010

(54) Command latch and pin latch system

(76) Inventor: Zeljko Baic, Sylmar, CA (US)

Correspondence Address: KLEIN, DENATALE, GOLDNER, COOPER et. al., P.O. BOX 11172, BAKERSFIELD, CA, 93389-1172, US

(21) Appl. No.: 12/386,686

(22) Filed: Apr. 21, 2009

(51) Int. Cl. E05C 1/12; E05C 19/12; E05C 19/10; E05C 1/06

(52) U.S. Cl. 292/158; 292/113; 292/100; 292/139

(57) ABSTRACT

A latching system for releasably securing a first member to a second member in a closed position. The latching system includes a command latch assembly comprising a hook latch assembly including a handle selectively movable from a first handle position toward a second handle position and a hook member adapted to selectively engage a first keeper when the handle is in the first handle position and to disengage from the first keeper when the handle is moved to the second handle position. The latching system also includes a remotely located slave latch assembly comprising a pin latch assembly adapted to secure a second keeper to the pin latch assembly when the handle of the hook latch assembly is in the first handle position and to disengage the second keeper when the handle of the hook latch assembly is moved to the second handle position.

### BACKGROUND

The present disclosure relates to a latching system for releasably securing a first member to a second member in a closed position, and in particular to a latching system including a command latch adapted to operate a remotely located slave latch.

Many types of latches are used in connection with aircraft to releasably secure two members or structures of the aircraft together in a closed position, such as the housing portions of an engine cowling. Such latches are subjected to substantial forces generated during use. Aircraft latches must also prevent inadvertent opening of the latch that could be caused by vibratory or other forces applied to the latch. Aircraft latches are sometimes located in substantially inaccessible locations making direct manual operation of the latch difficult if not impossible. Aircraft latches are sometimes also located in blind locations such that a latch cannot be visually inspected to confirm that the latching system is properly closed and securing the two aircraft members joined together in a closed position.

Features and advantages of the disclosure will be set forth in part in the description which follows and the accompanying drawings described below, wherein an embodiment of the disclosure is described and shown, and in part will become apparent upon examination of the following detailed description taken in conjunction with the accompanying drawings.

### SUMMARY OF THE INVENTION

The disclosed device is a latching system for releasably securing a first member to a second member in a closed position. The latching system comprises a command latch assembly operatively coupled to a remotely located slave latch assembly. The command latch assembly comprises a hook latch assembly attached to the first member and a first keeper attached to the second member. The hook latch assembly includes a handle selectively manually movable from a first handle position toward a second handle position, and a hook member adapted to selectively engage the first keeper when the handle is in the first handle position and to disengage from the first keeper when the handle is moved to the second handle position.

The slave latch assembly comprises a pin latch assembly adapted to be attached to the first member and a second keeper adapted to be attached to the second member. The pin latch assembly includes a pin selectively movable between a retracted position and an extended position. The pin is adapted to release the second keeper from the pin latch assembly when the pin is in the retracted position and secure the strut and the second keeper to the pin latch assembly when the pin is in the extended position. A safety device movable from a first position, wherein the safety device prevents movement of the pin to the extended position, to a second position, wherein the safety device does not prevent movement of the pin to the extended position, prevents the slave latch from closing when the slave latch in not properly positioned, thereby preventing the slave latch from closing and providing a false indication at the command latch that the second keeper has been properly secured.

A coupler member has a first end operatively associated with the handle of the hook latch assembly and a second end operatively associated with the pin of the pin latch assembly such that selective movement of the handle of the hook latch assembly is adapted to move the pin of the pin latch assembly between the extended and retracted positions of the pin.

### BRIEF DESCRIPTION OF THE DRAWINGS

FIG. 1 is an environmental view of a latching system in accordance with an embodiment of the present disclosure.

FIG. 2 is a top view of the command latch assembly.

FIG. 3 is a side view of the command latch assembly, showing the handle movement as the handle is pivoted from the latched to unlatched positions.

FIG. 4 is an exploded view of the hook latch assembly.

FIG. 5 is a bottom perspective view of the command latch assembly in the closed position, showing the coupler attached.

FIG. 6 is a perspective view of a latching system in accordance with an embodiment of the present disclosure.

FIG. 7 is a perspective view of the pin latch assembly.

FIG. 8 an exploded view of the pin latch assembly.

FIG. 9 is a side view of the slave latch assembly with the struts fully deployed.

FIG. 10a through 10d are side views of the command latch and the slave latch showing the opening sequence.

FIG. 11 is a perspective view of the pin latch assembly.

FIG. 12 is a view of the end of the strut and the safety device

FIG. 13 is a perspective view of an alternate embodiment of the pin latch assembly.

### DETAILED DESCRIPTION

While the present disclosure may be susceptible to embodiment in different forms, there is shown in the drawings, and herein will be described in detail, an embodiment with the understanding that the present description is to be considered an exemplification of the principals of the disclosure and is not intended to limit the disclosure to the details of construction, methods and arrangements of components set forth in the following description or illustrated in the drawings.

The present disclosure is directed to a latching system for releasably securing a first member to a second member in a closed position, such as members or panels of an aircraft, such as an engine cowling. The latching system 10 includes a command latch 12 and a remotely located slave latch 22.

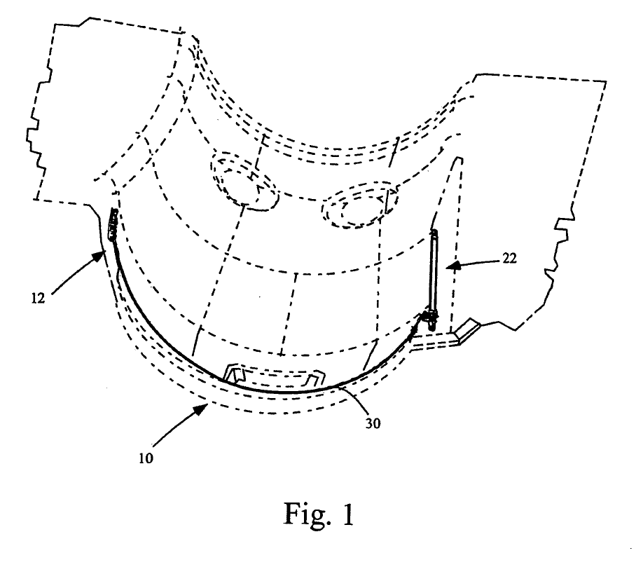

FIG. 1 shows an environmental view of the latching system 10 in use latching and retaining an airplane cowling. The command latch 12 is connected to the slave latch 22 through the coupler member 30. The command latch 12 is adapted to be coupled to the first member of an aircraft and the first keeper 16 is adapted to be coupled to a second member of an aircraft. The slave latch 22 has a pin latch 24 adapted to be coupled to the first member of an aircraft and the second keeper 26 is adapted to be coupled to a second member of an aircraft. It is to be appreciated that the presently disclosed latching system may be used in retaining other first and second members, and is not limited to the use shown in FIG. 1.

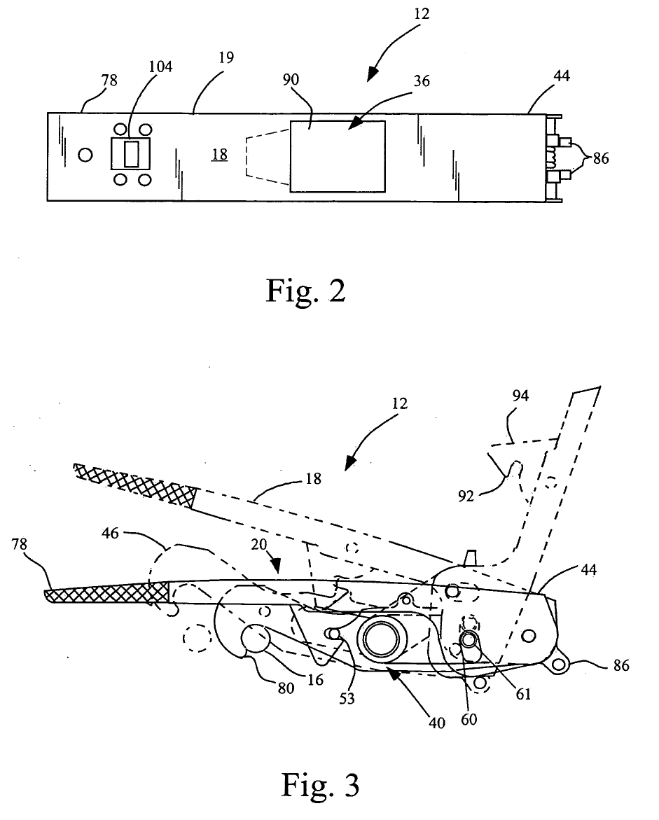

FIGS. 2 through 5 show various views of the command latch 12. The command latch 12 includes a hook latch assembly 14 and a first keeper 16. The command latch 12 comprises a handle 18 having a first end 44 and a second end 78, the handle second end 78 being pivotable about end connector 61 when the command latch 12 is activated to release both the command latch 12 and the slave latch 22. The handle first end 44 is pivotally connected to the arms 86 and the hook member 20, through the use of an end connector 61, for example a pin, shaft or fastener disposed within a bushing 57, and the handle first end 44, arms 86, and hook member 20 pivot about a common axis that is generally transverse to the hook member 20 longitudinal axis. The trigger 36 can have an actuator pad 90 which can be actuated by the user pressing the actuator pad 90 with their finger or an object. Pressing the trigger 36, or the trigger 36 and the actuator pad 90, releases the finger 92 from the trigger retention lock member 53, and allows the handle 18 to be moved from a first handle 18 position to a second handle 18 position, wherein the handle second end 78 is raised relative to the handle first end 44.

The trigger 36 and the actuator pad 90 are manually accessible through an aperture in the top wall 19 of the handle 18 such that the trigger 36 and the actuator pad 90 may be manually pivoted from a closed position to an open position. The movement of the handle 18 from a first handle 18 position to a second handle 18 position also causes the arms 86 to be moved in the direction of the handle second end 78 and moves the arms 86 beneath the handle 18. The movement of the arms 86 causes the coupler 30, which is attached to the arms 86 at the coupler member first end 32, to pull upon and activate the slave latch 22. There can be a screwdriver slot 104 in the handle top wall 19 that provides a receptacle for the placement of a screwdriver, wherein rotation of the screwdriver causes a rotation of the screwdriver slot 104, providing additional leverage and reducing the force necessary to open the command latch 12. The initial movement of the handle 18 exerts no pulling motion on the arms 86 and therefore no pulling motion is transmitted to the coupler 30 through the coupler first end 32.

Shown in FIG. 3 is a side view of the command latch 12, and shows the movement of the command latch 12 as the trigger 36, or the trigger 36 and actuator pad 90, release the hook member 20 from the first keeper 16. The trigger 36 and actuator pad 90 can act upon a finger 92 that is attached to an actuator arm 94. The trigger retention lock member 53 has been released by the finger 92 as the handle 18 pivots upwards towards the release position. The movement of the arms 86 resulting from the pivoting of the handle 18 from a first handle 18 position to a second handle 18 position can be seen in this Figure. The handle first end 44 pivots downward as the handle second end 78 raises relative to the first keeper 16. The hook 80 at the second end 46 of the hook member 20 can be seen gripping the first keeper 16 and then clearing and releasing the first keeper 16 as the handle 18 is raised into the unlatched position. An over-center linkage 40 includes left and right components located to either side of the hook 20. The over-center linkage assembly 40 moves as the handle 18 is pivoted from a first handle 18 position to a second handle 18 position, releasing the trigger retention lock member 53 from the finger 92 and the first keeper 16 from the hook 80 at the second end 46 of the hook member 20. The handle 18 has a free travel range, wherein the handle 18 moves but does not operate the slave latch 22 until the handle 18 has moved through the range of free travel, wherein the range of free travel is 10 to 20 degrees depending upon the installation.

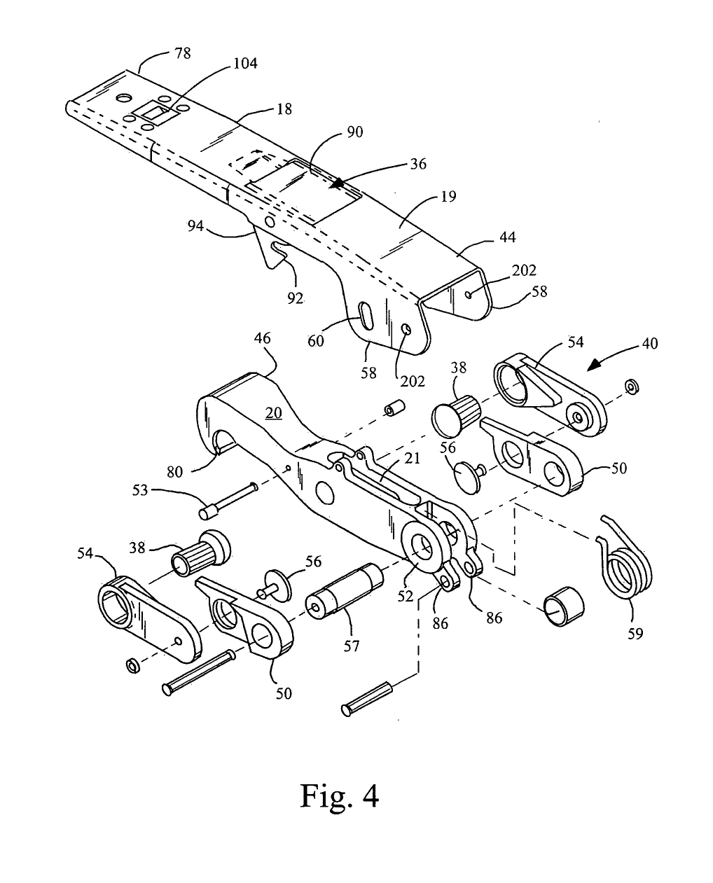

FIG. 4 is an exploded view of the hook latch assembly 14. The handle 18 is lifted away from the hook member 20, thereby proving clearer views of the hook member 20 and the over-center linkage assembly 40. The hook member 20 has a first end 52 and a second end 46, and comprises a longitudinal axis. The over-center linkage 40 comprises first links 50 and second links 54, and the first links 50 are pivotally connected to the second links 54 through center connectors 56, and the center connectors 56 form a mutual pivot axis for the links 50 and 54. This axis is displaced on the links 50 and 54 from the link's 50 and 54 attachments to the rivet 38 and the bushing 57 and end connector 61. The links 50 and 54 are arraigned in pairs on either side of the hook member 20. The first links 50 are pivotally connected to the hook member 20 at the hook member first end 52 through an end connector 61 and a bushing 57 disposed within the hook member first end 52. The second links 54 are pivotally connected to the rivet 38, thereby moving the hook member 20 when the handle 18 is released from the locked position. The hook member 20 also includes upper and lower apertures 21 and 23. The rivet 38 is moved by the over-center linkage assembly 40.

The hook 80 is located at the hook member second end 46, and is disengaged by the movement of the over-center linkage 40 movement resulting from the activation of the trigger 36, or the trigger 36 and the actuator pad 96. Activation of the trigger 36, or the trigger 36 and the actuator pad 96, causes a finger 92 attached to an actuator arm 94 to move and release a trigger retention lock member 53 on the hook member 20.

The handle 18 includes a pair of spaced apart and generally parallel wing walls 58 and the wing walls 58 each have respective apertures 60. The apertures 60 are operatively coupled to the center connectors 56, and when the handle 18 is moved from the first handle 18 position to the second handle 18 position the center connectors 56 move within the apertures. The end connector 61 engages a handle aperture 202 and is disposed within the bushing 57 in the hook member first end 52. The apertures 60 also provide for lost motion between the handle 18 and the center connectors 56 such that the over-center linkage 40 and the handle 18 may travel approximately 15 degrees before the hook 80 or the slave latch 22 begin motion. Additionally, the apertures 60 prevent the over-center linkage 40 from unlocking when the handle 18 is in the flush position. A resilient biasing member 59, such as a spring, resiliently biases the handle 18 from the closed first position to the open second position. The screwdriver slot 104 allows a screwdriver to serve as an extension of the handle 18, thereby providing additional leverage for the opening of the command latch 12 and the resultant operation of the slave latch 22.

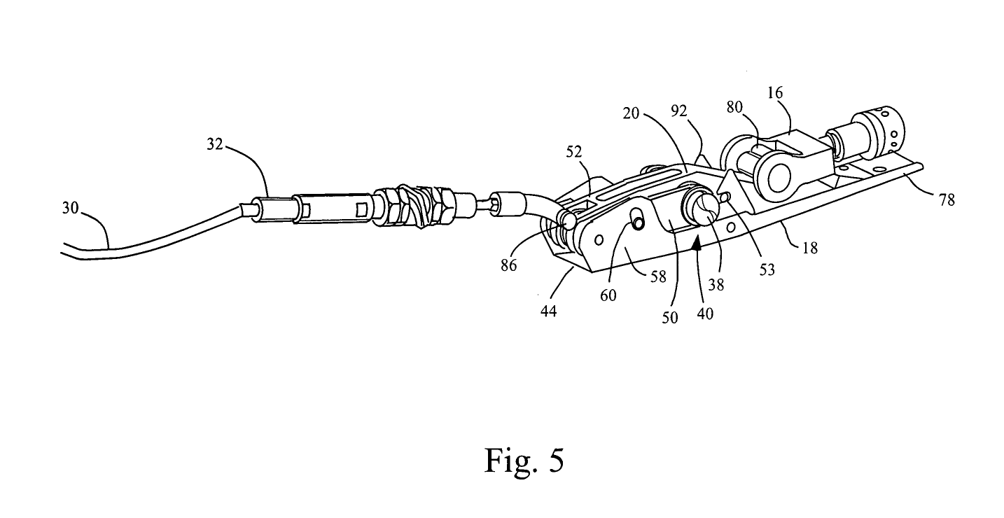

FIG. 5 is a perspective view of the bottom of the command latch assembly 12, and shows the connection of the coupler member 30 at the coupler member first end 32 to the arms 86 of the hook member 20. The command latch 12 is adapted to be coupled to a first member of an aircraft and the keeper 16 is adapted to be coupled to a second member of an aircraft. The coupler member 30 has a coupler member first end 32 that is connected through the hook member arms 86, end connector 61, and bushing 57 to the first links 50 of the over-center linkage 40, and the movement transmitted by the handle 18 through the over center linkage 40 as it is activated releases the hook member 20 from the first keeper 16. The motion also pulls the coupler member 30 releasing the remote slave latch 22, which is not shown. The hook member 20 has a hook member first end 52 that lies between the generally parallel wing walls 58 located at the handle first end 44. The hook member first end 52 is attached to the apertures 202 in the wing walls 58 through an end connector 61. The hook 80 at the second end 78 of the hook member 20 can be seen clasping the first keeper 16, as can the finger 92 be seen grasping the trigger retention lock member 53. The handle 18 has a free travel range of between 0.50 to 1.00 inches before the hook 80 clears the first keeper 16. The first keeper 16 is adjacent to the handle second end 78 when the command latch 12 is the engaged or closed position. The arms 86 are connected to the coupler member first end 32, and transmit the rotational force from the pivoting of the handle 18.

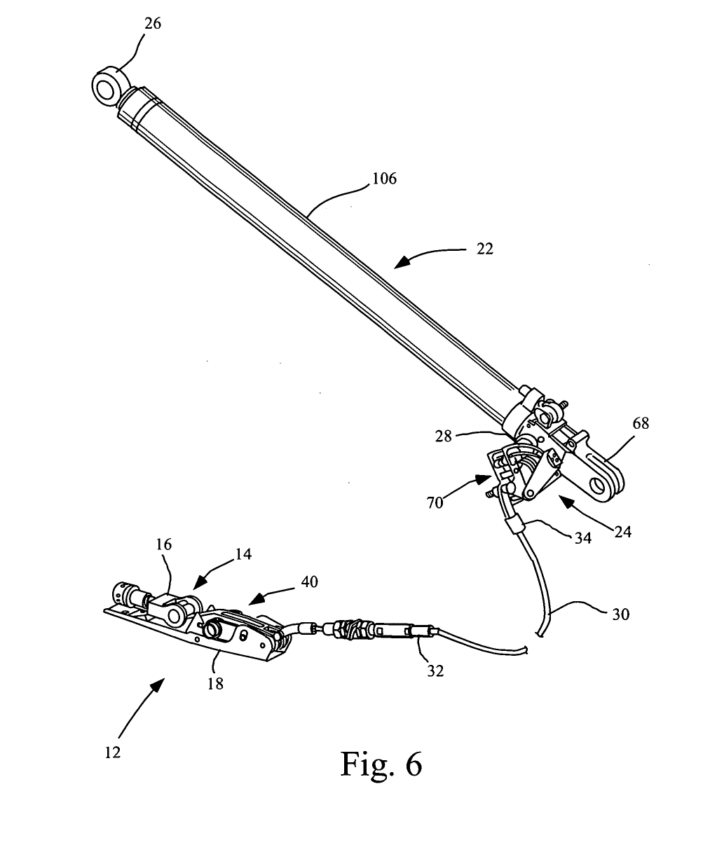

Shown in FIG. 6 is a perspective view of the command latch 12 and the slave latch assembly 22, along with the coupler 30. The command latch 12 comprises a handle 18, a hook latch assembly 14 which is connected to the first keeper 16 and an over-center linkage 40. The hook latch assembly 14 is adapted to be attached to the aircraft first member and the first keeper 16 is adapted to be attached to the aircraft second member. A coupler member 30 is disposed between the coupler member first end 32 and the coupler member second end 34, and transmits the movement of the coupler first end 32 to the coupler member second end 34 during operation of the latching system, wherein the coupler member 30 joins and transmits the movement from the master or command latch assembly 12 to the remote or slave latch assembly 22. The slave latch assembly 22 comprises a pin latch assembly 24 and a second keeper 26. The pin latch assembly 24 includes a pin 28 that is operatively connected to and operated through the operation of a cam assembly 70. The cam assembly 70 is coupled to the coupler member second end 34 and transmits the imparted activation motion from the command latch assembly 12 to the pin latch assembly 24. The pin latch assembly 24 has a body 68 that is adapted to be attached to the aircraft first member. There is a second keeper 26 that is adapted to be attached to the aircraft second member. If desired the slave latch assembly 22 may comprise a strut assembly which comprises a fixed strut 106 operatively connected to the body 68 of the pin latch assembly 24, and the retractable struts 108.

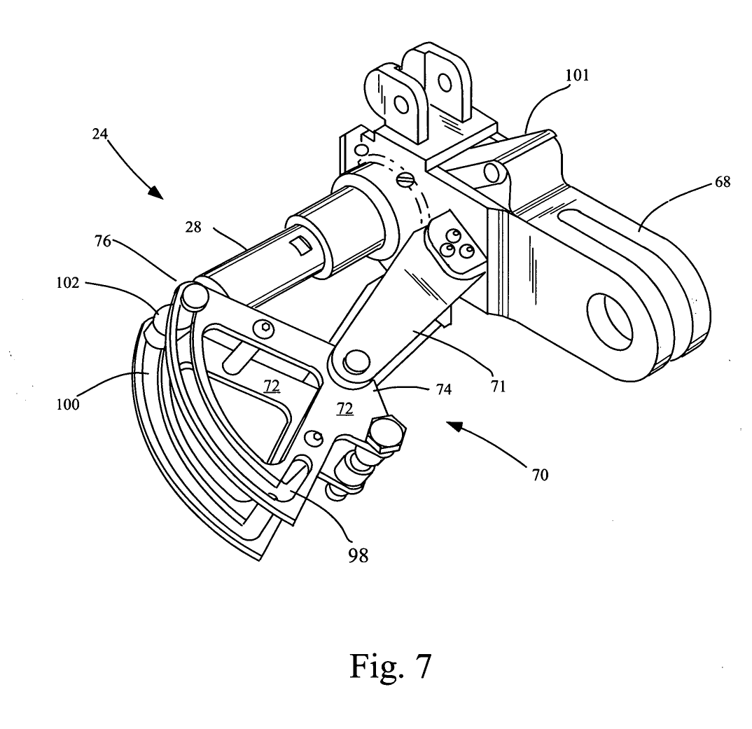

FIGS. 7 through 9 show various views of the slave latch assembly 22. FIG. 7 is a close-up perspective view of the pin latch assembly 24. The cam assembly 70 comprises a pair of generally parallel cam members 72, having a first end 74 pivotally connected to the pin latch assembly body 68 through a pair of generally parallel retention members 71, and a second end 76 operatively connected to the pin 28 through an actuator member 102.

During unlatching of the slave latch 22, the connector second end 34 pulls the cam assembly 70 away from the pin 28 wherein the cams 72 pivot on the retention members 71 and the actuator member 102 travels along the first slot 98 to the offset second slot 100. The actuator member 102 then reaches the full open position of the slave latch 22 wherein the pin 28 is retracted and pulled free from the second keeper 26 and the second keeper 26 is released, opening the cowling. The command latch 12 is opened further and the actuator member 102 moves further along the second slot 100. When the command latch 12 reaches the full range of travel the actuator member 102 is at the end or terminus of the second slot 100 and the pin 28 is fully retracted from the receptacle 65 of the body 68. The first slot 98 and the second slot 100 are offset from one another, and the actuator member 102 travels through the first slot 98 during the initial travel of the slave latch 22 unlocking operation by the command latch 12, and completes the opening of the slave latch 22 by the command latch 12 by traveling in the second slot 100. The slave latch 22 travels 1.27 inches from the bottom of the first slot 98 to full retraction of the pin 28 and the stop travel point of the second slot 100.

During the latching of the slave latch 22, the actuator member 102 travels along the second slot 100 thereby extending the pin 28 into the receptacle 65 in the body 68. Once the pin 28 is fully extended into the body 68, the movement force shifts from pushing the pin 28 into the aperture 65 into further movement by the actuator member 102 to the end of the second slot 100 and then into the first slot 98. The safety device 101 can comprise a spring loaded lever, which includes a biasing member 103 that biases the safety device 101 into the body 68, whereby the safety device 101 blocks the receptacle 65 such that the pin 28 cannot enter the receptacle 65 when the pin holder 99 of the second keeper 26 has been released by the retraction of the pin 28. The biasing member 103 biases the safety device 101 into the blocking position following retraction of the pin 28. The second keeper pin holder 99 lifts and moves the safety device 101 away from the receptacle 65 and thus opens the receptacle 65 for entry of the pin 28 into the second keeper pin holder 99, wherein the pin 28 retains the second keeper pin holder 99 within the body 68.

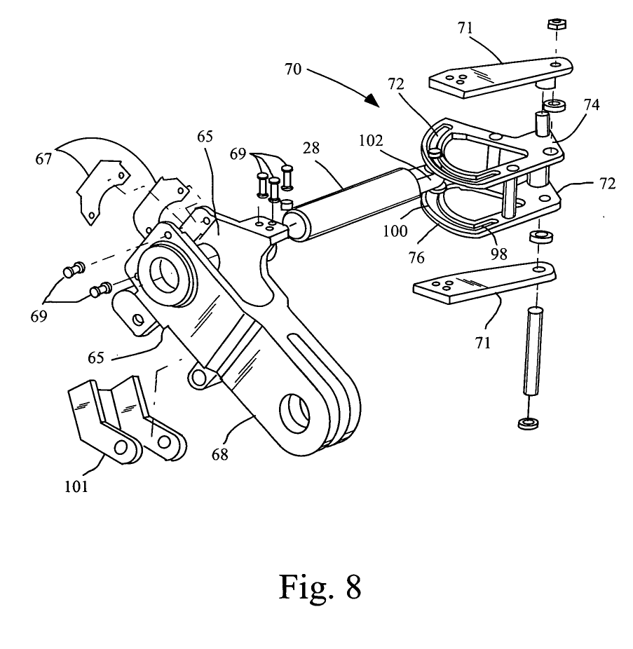

As can be seen in FIG. 8, the cam assembly 70 is pivotally attached to the body 68 by a pair of generally parallel retention members 71, wherein the cam members 72 lie between the retention members 71. The retention members 71 are attached to the body 68 through the use of connectors 69, such as the rivets that are shown. The pin 28 enters into and operates within a pair of apertures 65 that retain and align the pin 28 during the operation of the slave latch 22. The pin 28 can have a beveled end that would mate with a matching bevel on the inside surface of the aperture 65 opposite the cam assembly 70. The body 68 can be attached to the fixed strut 106 through a pair of generally opposed leaf springs 67, and connectors 69 such as the rivets that are shown. The slave latch 22 is reengaged by the reversal of the coupler 30 movement wherein the cam assembly 70 pivots and the actuator member 102 travels through the second slot 100 and then through the offset first slot 98. The second keeper pin holder 99 will have moved the safety device 101 out of the pin's 28 path such that the pin 28 enters into receptacle 65 and retains the second keeper pin holder 99.

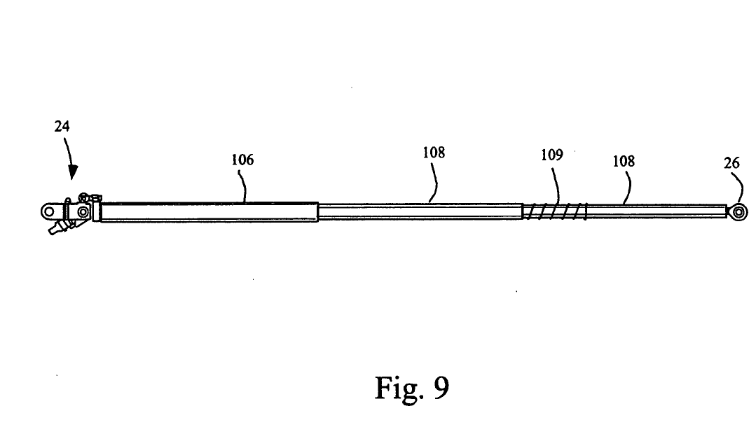

Shown in FIG. 9 is a side view of the slave latch assembly 22 with the fixed strut 106 and the retractable struts 108 fully deployed. The pin latch assembly 24 is moved away from the second keeper 26, and the first aircraft member and the second aircraft members are released from engagement with one another. The slave latch 22 can serve as a second member support such that a hinge is not required, although a hinge may be used if desired. The first aircraft member and the second aircraft members are brought into engagement following the retraction of the retractable struts 108 fully into the fixed strut 106, and the reengagement of the pin 28 into the second keeper pin holder 99. The retractable struts 108 retract into the fixed strut 106, and a resilient compression means 109, such as the spring shown, is compressed by the movement of the retractable struts 108. The compression means 109 assists in deploying the retractable struts 108 from the fixed strut 106, when the pin 28 is retracted and releases the second keeper 26. The strut assembly has an extendable length of approximately 20 inches to 60 inches.

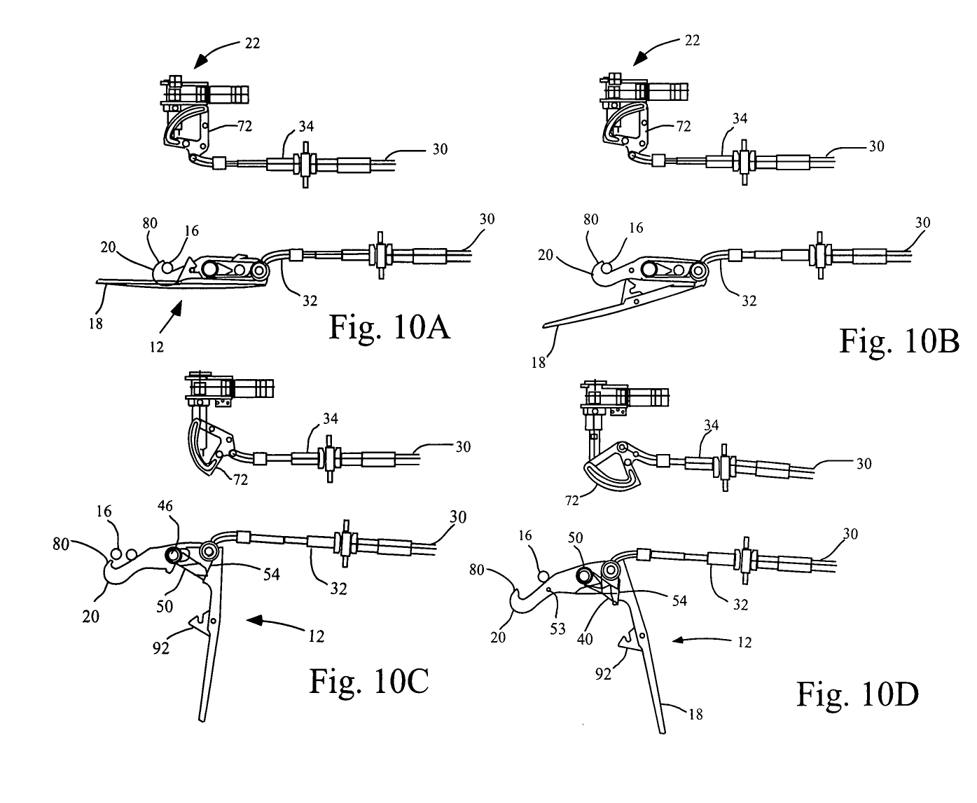

FIGS. 10a through 10d show the command latch 12 and the slave latch 22 in the stages of opening from the fully closed position of 10a to the filly open position of 10d. In FIG. 10a the handle 18 is adjacent to the hook member 20 and the hook 80 is clasping the first keeper 16. The first 32 and second 34 ends of the coupler 30 have not moved, and therefore the cam 72 is also in an umnoved position. In FIG. 10b the handle 18 has moved to the end of the free travel, and the handle 18 is no longer adjacent to the hook member 20 but the slave latch 22 has not begun to open. The hook 80 is still clasping the first keeper 16 and the slave latch 22, and therefore the cams 72, have not been moved as the coupler first end 32 has not transmitted any motion to the coupler 30 and then onward to the coupler second end 34.

As can be seen in FIG. 10c, the handle 18 is partially through the range of movement to open the slave latch 22. The hook 80 of the hook member 20 has released the first keeper 16 and the finger 92 is likewise clear of the trigger retention lock member 53. The first link 50 of the over center linkage 40 has begun to pivot away from the second link 54. The coupler first end 32 has moved and the coupler 30 has transmitted this movement to the coupler second end 34. The cams 72 have pivoted, and the actuator member 102 has moved out of the first slot 98 and into the second slot 100. The pin 28 has started its movement away from the body 68, and the second keeper 26 will have entered the initial release stages. In FIG. 10d the command latch 12 has completed the full range of travel, and is now completely open. The slave latch 22 has also completed its full range of travel, and the pin 28 has retracted and released the second keeper 26. The actuator member 102 is at the end of the second slot 100. The finger 92 and trigger retention lock member 53 are separated, as are the hook 80 and first keeper 16. The first link 50 of the over center linkage 40 can be seen pivoted away from the second link 54.

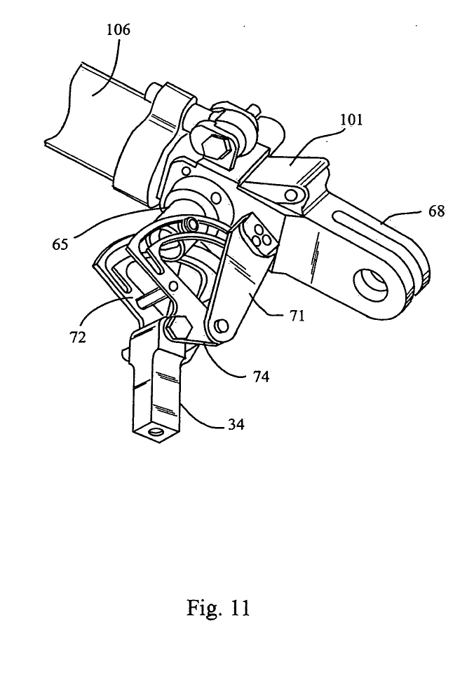

Shown in FIG. 11 is a view of the pin latch assembly 24, and the cam assembly 70 is at the mid-way point of closing the command latch 12. The pin 28 is fully extended into the receptacle 65 and the safety device 101 is lifted out of position by the second keeper pin holder 99. The pin 28 is in the second keeper pin holder 99. The actuator member 102 is in the second slot 100 of the cams 72, and the cams 72 have pivoted on the retention members 71 that are attached to the body 68. An alternate connection for the connector second end 34 is shown.

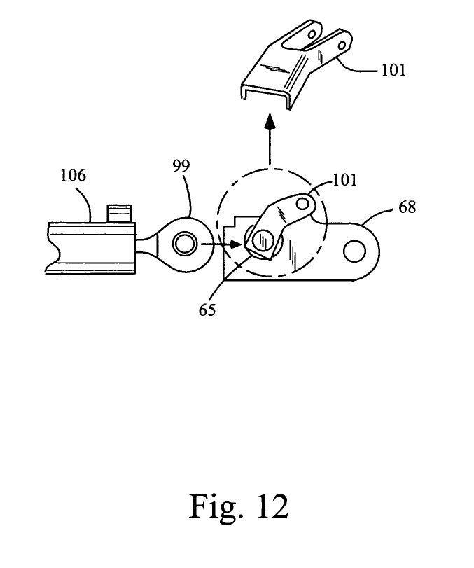

FIG. 12 shows the second keeper pin holder 99 that is retained by the pin 28 removed from the body 68 of the pin latch assembly 24. The safety device 101 is biased into the receptacle 65 of the body 68 and would thus block entry by the pin 28 into the receptacle 65, thereby preventing the slave latch 22 from closing when the slave latch 22 in not properly positioned, and thereby preventing the slave latch 22 from closing and providing a false indication at the command latch 12 that the second keeper 26 has been properly secured.

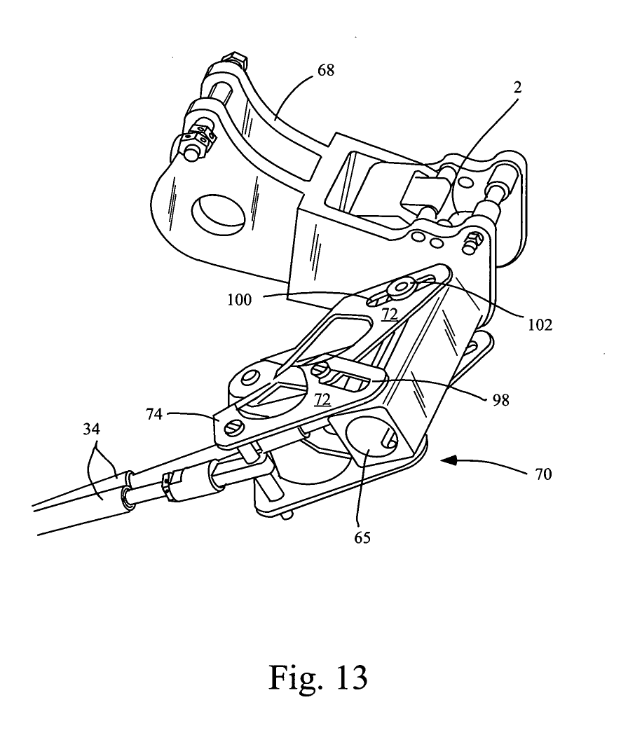

FIG. 13 shows an alternate embodiment of the pin latch assembly 24. Two connectors 30 are shown and each has a connector second end 34. The actuator member 102 moves within a first slot 98 and a second slot 100 while moving the pin 28. The pin 28 travels within the receptacle 65 and biases the safety device 101 away from the receptacle 65. The cam assembly 70 comprises cams 72 that are pivotally attached to the body 68.

The command latch and the slave latch operate cooperatively to latch and lock two adjacent members or panels of an aircraft. The slave latch can be, though need not be, located in an inaccessible location once the airplane is constructed. The command latch and slave latch are joined by a cable or similar flexible bond that is capable of transmitting the force and or movement motion generated by the operation of the command latch to the slave latch. The slave latch has a fixed strut and deployable struts that move away from the pin latch when the latch is released, thereby allowing the joined first and second members to be opened for repairs or inspection of the components contained within the covers. The slave latch supports the weight of the engine cowling such that a hinge is not needed, although one or more may be provided. There is a free range of travel by the command latch, wherein the command latch moves in the range of 10 to 20 degrees from the initial closed and flush position where the handle is flush with the outer skin of the airplane, to an initial opening stage where the command latch has been lifted away from the skin but has not begun to unlatch or operate upon the slave latch.

The activation of the trigger, or the trigger and the activation pad, followed by a lifting of the handle moves the finger away from the trigger retention lock member. The movement of the handle during the free travel movement does not move the linkages of the over center linkages. As the handle is moving during the free range of travel the slave latch does not receive movement from the coupler and therefore the slave latch does not begin movement. After the handle has completed the free travel movement the over center linkage starts movement as does the coupler, thereby initiating movement of the slave latch. The over center linkage connector member begins movement along the longitudinal slot of the hook member, and the finger of the hook member begins to release the first keeper. The slave latch attains a fully open position, wherein the pin has been withdrawn from and releases the retractable strut when the command latch has completed about 70 to 80 percent of its travel range. At this position the actuator member is not at the end of the second slot of the cam member. The continued motion of the command latch after it attains the full opening travel range continues to pull on the coupler and moves the actuator member to the end of the second slot in the cam member and therefore pulls the pin further out of the body receptacle but does not result in further movement of the strut assembly.

While the above is a description of various embodiments of the present invention, further modifications may be employed without departing from the spirit and scope of the present invention. Thus the scope of the invention should not be limited by the specific structures disclosed. Instead the true scope of the invention should be determined by the appended claims.

What is claimed is:

1. A latching system for releasably securing a first member to a second member in a closed position, the latching system comprising:
a command latch assembly comprising a hook latch assembly adapted to be attached to the first member and a first keeper adapted to be attached to the second member, the hook latch assembly including a handle selectively movable from a first handle position toward a second handle position, and a hook member adapted to selectively engage the first keeper when the handle is in the first handle position and to disengage from the first keeper when the handle is moved to the second handle position;
a slave latch assembly comprising a pin latch assembly adapted to be attached to the first member and a second keeper adapted to be attached to the second member, the pin latch assembly including a pin selectively movable between a retracted position and an extended position, the pin adapted to secure the second keeper to the pin latch assembly when the pin is in the extended position; and
a coupler member having a first end operatively associated with the handle of the hook latch assembly and a second end operatively associated with the pin of the pin latch assembly such that movement of the handle of the hook latch assembly is adapted to move the pin of the pin latch assembly.

2. The latching system of claim 1 wherein the handle of the hook latch assembly includes a trigger adapted to releasably engage the first keeper when the handle is in the first handle position.

3. The latching system of claim 1 wherein the hook latch assembly includes a connector member adapted to couple the hook latch assembly to the first member, and an over-center linkage coupling the handle to the hook member such that when the handle is moved from the first handle position to the second handle position the over-center linkage moves the hook member to disengage from the first keeper.

4. The latching system of claim 3 wherein the hook member includes a first end coupled to a first end of the handle, a second end adapted to selectively engage the first keeper and an elongate slot, the connector member extending through the slot such that the hook member is slideable with respect to the connector member when the handle is moved from the first handle position toward the second handle position.

5. The latching system of claim 3 wherein the first end of the coupler member is coupled to the over-center linkage.

6. The latching system of claim 3 wherein the over-center linkage includes a first link pivotally coupled to a first end of the hook member and to a first end of the handle, a second link coupled to the connector member, and a center connector pivotally coupling the first link to the second link, the handle including a wing wall having an aperture, the center connector of the over-center linkage being located within the aperture of the wing wall such that the wing wall is adapted to engage the center connector when the handle is moved between the first and second handle positions.

7. The latching system of claim 1 wherein the pin latch assembly includes a receptacle adapted to removably receive the second keeper, the pin being located in the receptacle when in the extended position to secure the second keeper to the pin latch assembly, and a safety device movable between a first position located within the pin path wherein the safety device prevents movement of the pin from the retracted position to the extended position and a second position wherein the safety device does not prevent movement of the pin from the retracted position to the extended position, the safety device being movable from the first position to the second position by insertion of the second keeper into the receptacle.

8. The latching system of claim 1 wherein the pin latch assembly includes a body, and a cam assembly for moving the pin between the retracted and extended pin positions, the cam assembly including a pair of cam members having a first end pivotally attached to the body and a second end operatively coupled to the pin, the second end of the coupler member being operatively coupled to the cam member.

9. A command latch assembly for releasably securing a first member to a second member in a closed position and for actuating a remotely located slave latch, the command latch assembly comprising:
a hook latch assembly adapted to be attached to the first member and including a handle having a first end and a second end, a hook member having a first end coupled to the first end of the handle and a second end including a hook, an over-center linkage having a first end coupled to the first end of the hook member and a second end adapted to be coupled to the first member, and an arm attached to the over-center linkage, the arm adapted to be coupled to the remotely located slave latch; and
a keeper adapted to be attached to the second member, the hook member adapted to selectively engage the keeper when the handle is in a first handle position and to disengage from the keeper when the handle is moved to a second handle position;
whereby the arm of the hook latch assembly is adapted to be coupled to the remotely located slave latch such that movement of the handle of the hook latch assembly between the first and second handle positions is operative to actuate the remotely located slave latch.

10. The command latch assembly of claim 9 wherein the handle, hook member and arm are each adapted to pivot about a common axis.

11. The command latch assembly of claim 9 wherein the hook member includes a longitudinal slot, and a connector member is coupled to the second end of the over-center linkage and extends through the longitudinal slot in the hook member, the connector member adapted to be coupled to the first member.

12. The command latch of claim 9 wherein the over-center linkage includes a first link pivotally coupled to the first end of the hook member, a second link adapted to be coupled to the first member, and a center connector pivotally coupling the first link to the second link, the handle including a wing wall having an aperture, the center connector being located within the aperture of the wing wall such that the wing wall is adapted to engage the center connector when the handle is moved between the first and second handle positions.

13. A command latch assembly for releasably securing a first member to a second member in a closed position, the command latch comprising:
a keeper adapted to be attached to the second member; and
a hook latch assembly adapted to attached to the first member and including a handle having a first end, a second end and a screwdriver slot, a hook member having a first end coupled to the first end of the handle and a second end including a hook adapted to releasably engage the keeper, the handle being movable between a first handle position wherein the hook member engages the keeper and a second handle position wherein the hook member is disengaged from the keeper, the handle including a trigger adapted to releasably engage the keeper when the handle is in the first handle position to prevent movement of the handle toward the second handle position.

14. The command latch assembly of claim 13 wherein the trigger includes an actuator pad pivotally attached to the handle and a finger attached to the actuator pad by an arm, the handle including an aperture for providing manual access to the actuator pad of the trigger.

15. A slave latch assembly for releasably securing a first member to a second member in a closed position, the slave latch assembly comprising:
a keeper adapted to be attached to the second member; and
a pin latch assembly adapted to be attached to the first member, the pin latch assembly including a body having a receptacle adapted to removably receive the keeper, a pin selectively movable between a retracted position and an extended position, the pin being located within the receptacle when in the extended position to secure the keeper to the pin latch assembly, and a safety device movable between a first position located within the pin path wherein the safety device prevents movement of the pin from the retracted position to the extended position and a second position wherein the safety device does not prevent movement of the pin from the retracted position to the extended position, the safety device being movable from the first position to the second position by insertion of the second keeper into the receptacle.

16. The slave latch assembly of claim 15 including a cam assembly for moving the pin between the retracted and extended pin positions, the cam assembly including a pair of cam members having a first end pivotally coupled to the body and a second end coupled to the pin, the cam members being selectively pivotal between a first position wherein the cam members locate the pin in the extended pin position and a second position wherein the cam members locate the pin in the retracted pin position.

17. The slave latch assembly of claim 16 wherein the body includes a first slot and the cam members include a second slot, and an actuator member is located in the first and second slots and is selectively slideable within the first and second slots to selectively pivot the cam members between the first and second positions of the cam members.

18. The slave latch assembly of claim 17 wherein one of the first slot and second slot comprises a camming slot having a first slot segment and a second slot segment offset from the first slot segment.

19. The slave latch assembly of claim 16 including a strut assembly including a fixed strut having a first end adapted to be coupled to the second member and a second end adapted to be coupled to the keeper, and one or more extendable and retractable struts adapted to extend outwardly from the second end of the fixed strut, the extendable and retractable struts adapted to be coupled to the pin latch assembly.

20. The slave latch assembly of claim 15 including a biasing member for resiliently biasing the safety device from the second position toward the first position of the safety gate.

21. A pin latch assembly for releasably securing a first member to a second member, the pin latch assembly comprising:
a body adapted to be attached to the first member;
a pin coupled to the body, the pin being movable between a retracted position and an extended position, the pin adapted to releasably couple the body to the second member when the pin is in the extended position; and
a cam assembly for selectively moving the pin between the retracted and extended pin positions, the cam assembly including a pair of cam members having a first end pivotally coupled to the body and a second end coupled to the pin, the cam members being selectively pivotal between a first position wherein the cam members locate the pin in the extended pin position and a second position wherein the cam members locate the pin in the retracted pin position.

22. The pin latch assembly of claim 20 wherein the cam members include a first slot and a second slot, and an actuator member is located in the first and second slots and is selectively slideable within the first and second slots to selectively pivot the cam members between the first and second positions of the cam members.

23. The pin latch assembly of claim 20 wherein one of the first slot and second slot comprises a camming slot having a first slot segment and a second slot segment offset from the first slot segment.
